(19) United States
(12) Patent Application Publication
(10) Pub. No.: US 2015/0074132 A1
(43) Pub. Date: Mar. 12, 2015

(54) METHODS AND SYSTEMS FOR INMATE SEARCHING

(71) Applicant: Pigeon.LY, Las Vegas, NV (US)

(72) Inventor: Frederick Hutson, Las Vegas, NV (US)

(21) Appl. No.: 14/482,720

(22) Filed: Sep. 10, 2014

Related U.S. Application Data
(60) Provisional application No. 61/875,759, filed on Sep. 10, 2013.

(51) Int. Cl. G06F 17/30

(52) U.S. Cl. CPC G06F 17/30386; G06F 17/30091
USPC 707/758

(57) ABSTRACT

A method, computer system, and computer readable medium for processing and accessing prison inmate data, including extracting from a plurality of sources, using a computer, attributes information about individuals that have a criminal case; storing and organizing the extracted attributes information in a database; matching, using a computer, the extracted attributes information with attributes data on a plurality of government websites; determining whether an individual is currently in prison based on the matching; providing a real-time location of the individual based on the determining; and tracking the real-time location of the individual currently in prison for a duration of a prison term of the individual.

### CROSS REFERENCE TO RELATED APPLICATIONS

This application claims priority to U.S. Provisional Patent Application No. 61/875,759, filed Sep. 10, 2013, which is hereby incorporated herein by reference in its entirety.

### FIELD

This disclosure relates generally to an inmate searching, and more particularly to methods, system, and media for inmate searching.

### BACKGROUND

There are over 3000 prison institutions (County, State and Federal) spread across the U.S. that are home to about 2.3 million inmates. All the information about these 2.3 million inmates are public record, however most people have no idea how to navigate or access this data, and even if they're able to make some headway finding information on their loved one, there's still an untold number of connections between that data and even more data hidden away in another public record silo.

With advances in information technologies, there exists a need for methods and systems that address the aforementioned problems.

### SUMMARY

Various embodiments are generally directed to inmate searching to overcome the aforementioned problems.

In one embodiment, a method of processing and accessing prison inmate data, includes extracting from a plurality of sources, using a computer, attributes information about individuals that have a criminal case; storing and organizing the extracted attributes information in a database; matching, using a computer, the extracted attributes information with attributes data on a plurality of government websites; determining whether an individual is currently in prison based on the matching; providing a real-time location of the individual based on the determining; and tracking the real-time location of the individual currently in prison for a duration of a prison term of the individual.

In another embodiment, a computer system for processing and accessing prison inmate data, the computer system includes an extraction unit that is configured to extract, using at least one processor, from a plurality of sources attributes information about individuals that have a criminal case; a data storage unit including a memory that is configured to store instructions; a data processor that is configured to execute the instructions to store and organize the extracted attributes information in a database; match the extracted attributes information with attributes data on a plurality of Department of Corrections websites; determine whether an individual is currently in prison based on the matching; provide a real-time location of the individual based on the determining; and track the location of the individual currently in prison for a duration of a prison term of the individual.

In another embodiment, a non-transitory computer readable storage medium for processing and accessing prison inmate data, includes instructions that when executed by at least on processor cause a computer to perform: extracting from a plurality of sources attributes information about individuals that have a criminal case; storing and organizing the extracted attributes information in a database; matching the extracted attributes information with attributes data on a plurality of Department of Corrections websites; determining whether an individual is currently in prison based on the matching; providing a real-time location of the individual based on the determining; and tracking the location of the individual currently in prison for a duration of a prison term of the individual.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

Embodiments will now be described in connection with the associated drawings, in which:

FIG. 1 depicts a block diagram of an exemplary system 100 in accordance with one or more embodiments.

FIG. 2 depicts a block flow diagram of an exemplary method 200 in accordance with one or more embodiments.

FIG. 3 depicts a block diagram of an exemplary transformation of unorganized public records into real-time location tracking in accordance with one or more embodiments.

FIG. 4 depicts an exemplary architecture for implementing a computing device in accordance with one or more embodiments.

### DETAILED DESCRIPTION OF THE DRAWINGS

Exemplary embodiments are discussed in detail below. While specific exemplary embodiments are discussed, it should be understood that this is done for illustration purposes only. In describing and illustrating the exemplary embodiments, specific terminology is employed for the sake of clarity. However, the embodiments are not intended to be limited to the specific terminology so selected. A person skilled in the relevant art will recognize that other components and configurations may be used without parting from the spirit and scope of the embodiments. It is to be understood that each specific element includes all technical equivalents that operate in a similar manner to accomplish a similar purpose. The examples and embodiments described herein are non-limiting examples.

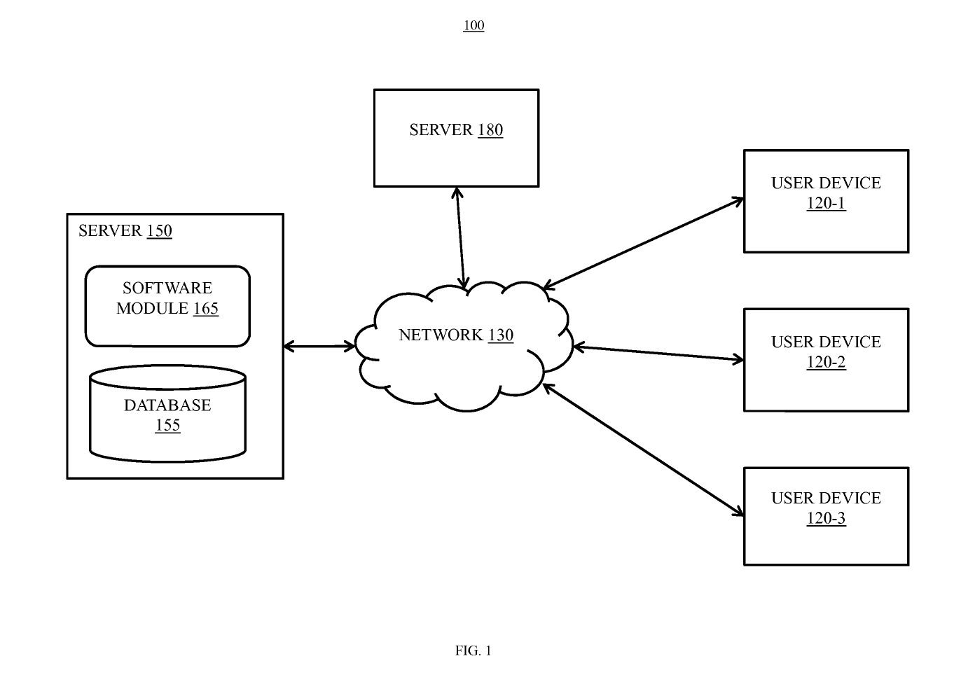

FIG. 1 depicts a block diagram of an exemplary system 100 in accordance with one or more embodiments. System 100 may include one or more user devices, e.g. user device 120-1, user device 120-2, and user device 120-3, network 130, server 150, database 155, software module 165, and server 180.

The one or more user devices, e.g. user device 120-1, user device 120-2, and user device 120-3, may be any type of computing device, including a mobile telephone, a laptop, tablet, or desktop computer having, a netbook, a video game device, a pager, a smart phone, an ultra-mobile personal computer (UMPC), or a personal data assistant (PDA). The one or more user devices may run one or more applications, such as Internet browsers, voice calls, video games, videoconferencing, and email, among others. The one or more user devices may be any combination of computing devices. These devices may be coupled to network 130.

Network 130 may provide network access, data transport and other services to the devices coupled to it. In general, network 130 may include and implement any commonly defined network architectures including those defined by standards bodies, such as the Global System for Mobile communication (GSM) Association, the Internet Engineering Task Force (IETF), and the Worldwide Interoperability for Microwave Access (WiMAX) forum. For example, network 130 may implement one or more of a GSM architecture, a General Packet Radio Service (GPRS) architecture, a Universal Mobile Telecommunications System (UMTS) architecture, and an evolution of UMTS referred to as Long Term Evolution (LTE). Network 130 may, again as an alternative or in conjunction with one or more of the above, implement a WiMAX architecture defined by the WiMAX forum. Network 130 may also comprise, for instance, a local area network (LAN), a wide area network (WAN), the Internet, a virtual LAN (VLAN), an enterprise LAN, a layer 3 virtual private network (VPN), an enterprise IP network, or any combination thereof.

Server 150 or server 180 may also be any type of computing device coupled to network 130, including but not limited to a personal computer, a server computer, a series of server computers, a mini computer, and a mainframe computer, or combinations thereof. Server 150 or server 180 may be a web server (or a series of servers) running a network operating system, examples of which may include but are not limited to Microsoft Windows Server, Novell NetWare, or Linux. Server 150 or server 180 may be used for and/or provide cloud and/or network computing. Although not shown in FIG. 1, server 150 and or server 180 may have connections to external systems like email, SMS messaging, text messaging, ad content providers, etc. Any of the features of server 150 may be also implemented in server 180 and vice versa.

Database 155 may be any type of database, including a database managed by a database management system (DBMS). A DBMS is typically implemented as an engine that controls organization, storage, management, and retrieval of data in a database. DBMSs frequently provide the ability to query, backup and replicate, enforce rules, provide security, do computation, perform change and access logging, and automate optimization. Examples of DBMSs include Oracle database, IBM DB2, Adaptive Server Enterprise, FileMaker, Microsoft Access, Microsoft SQL Server, MySQL, PostgreSQL, and a NoSQL implementation. A DBMS typically includes a modeling language, data structure, database query language, and transaction mechanism. The modeling language is used to define the schema of each database in the DBMS, according to the database model, which may include a hierarchical model, network model, relational model, object model, or some other applicable known or convenient organization. Data structures can include fields, records, files, objects, and any other applicable known or convenient structures for storing data. A DBMS may also include metadata about the data that is stored.

Software module 165 may be a module that is configured to send, process, and receive information at server 150. Software module 165 may provide another mechanism for sending and receiving data at server 150 besides handling requests through web server functionalities. Software module 165 may send and receive information using any technique for sending and receiving information between processes or devices including but not limited to using a scripting language, a remote procedure call, an email, a tweet, an application programming interface, Simple Object Access Protocol (SOAP) methods, Common Object Request Broker Architecture (CORBA), HTTP (Hypertext Transfer Protocol), REST (Representational State Transfer), any interface for software components to communicate with each other, using any other known technique for sending information from a one device to another, or any combination thereof.

Although software module 165 may be described in relation to server 150, software module 165 may reside on any other device. Further, the functionality of software module 165 may be duplicated on, distributed across, and/or performed by one or more other devices, either in whole or in part.

Current systems today requires a person to search multiple places/websites in order to determine which institution an inmate, e.g. their loved one, is incarcerated. With the system 100, a user can execute a nationwide search (Federal and State) for an inmate by entering the inmates name and/or inmate number one time on one website. One or more crawlers that are configured to be processed on a computer may access and download all the prison/inmate related databases it can find, and then algorithmically find connections between all available data points in various databases on a particular inmate to create a sort of knowledge graph. On the back-end, the system 100 may interface with all the individual online State and federal department of corrections websites so that the user does not have to. This allows the system 100 to do the heavy lifting for users and execute the searched on their behalf. Because the system 100 aggregates the data from separate sources and organizes it into a single database, it makes it more usable as well as valuable.

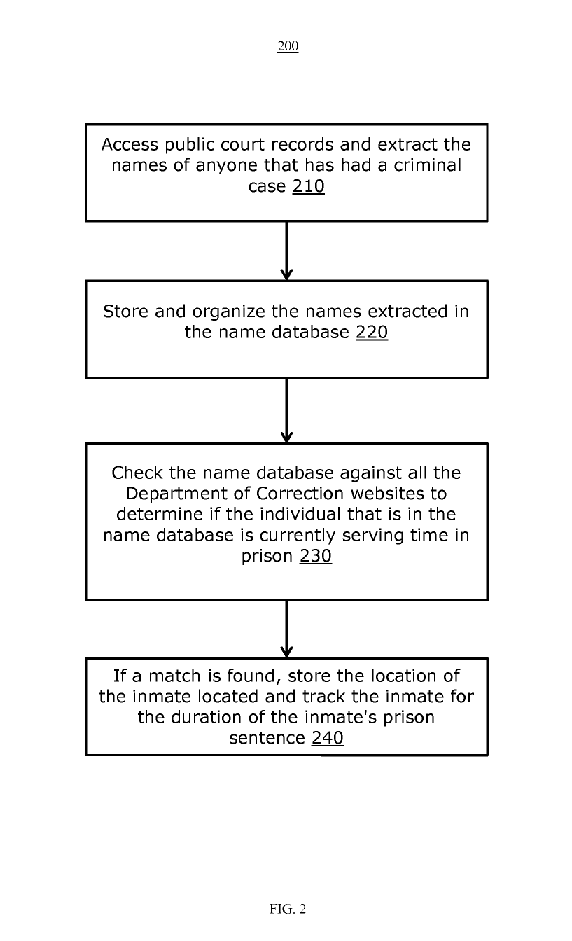

FIG. 2 depicts a block flow diagram of an exemplary method 200 in accordance with one or more embodiments.

In block 210, a data scraper may access public court records and extract the names of anyone that has had a criminal case. The data scraper may be implemented as software module 165, or on any of the computing devices or components thereof depicted in FIG. 1.

In block 220, the extracted names may be stored and organized in a name database. The name database may be implemented as database 155. The names may be stored and/or organized by software module 165 or by any of the computing devices or components thereof depicted in FIG. 1.

In block 230, name database may be checked against all the Department of

Corrections websites to determine if one or more individuals that are in the name database are currently serving time in prison. The name database may be checked by software module 165 or by any of the computing devices or components thereof depicted in FIG. 1.

In block 240, if there is a match, e.g. between people in the name database and websites examined, the location of the inmate that was located may be stored and the inmate may be tracked for the duration of his prison sentence. The inmate may be tracked by software module 165 or by any of the computing devices or components thereof depicted in FIG. 1.

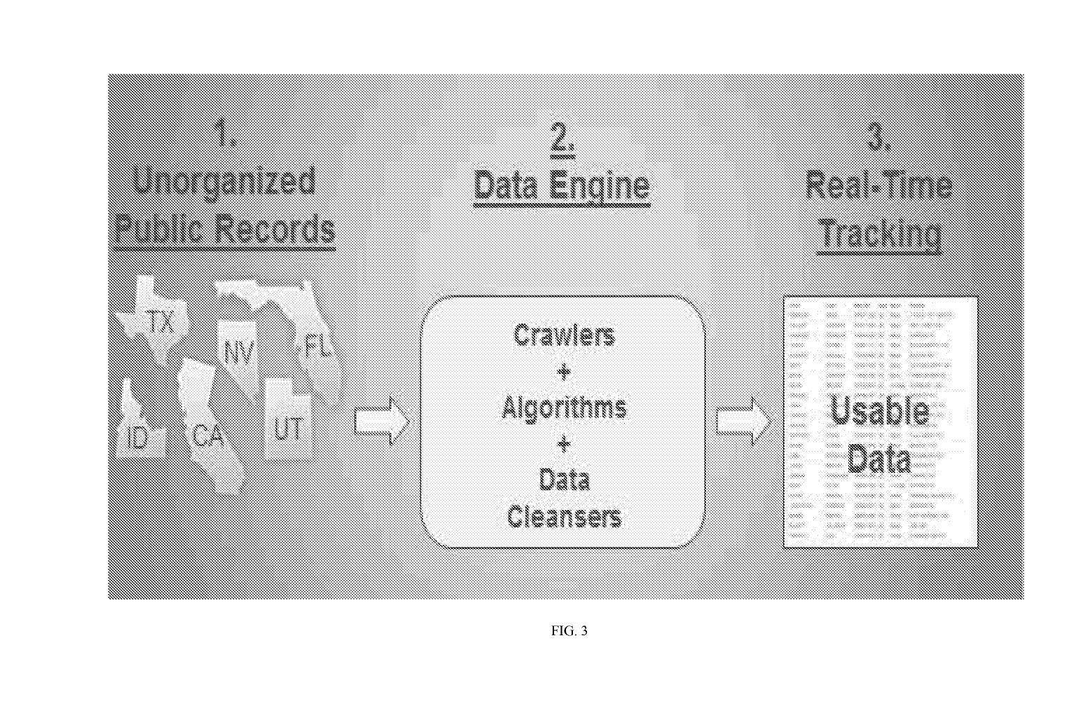

FIG. 3 depicts a block diagram of an exemplary transformation of unorganized public records into real-time location tracking, in accordance with one or more embodiments. For example, the unorganized public records may be public court records accessed in block 210. The data engine of FIG. 3 may implement one or more crawlers, algorithms, and data cleansers. For example, the data engine of FIG. 3 may perform the storing and organizing of the extracted names as discussed with respect to block 220. Further, the data engine of may perform all or some of the steps discussed with respect to blocks 230 and 240. The real-time location tracking using data of FIG. 3 may be result of the tracking of block 240.

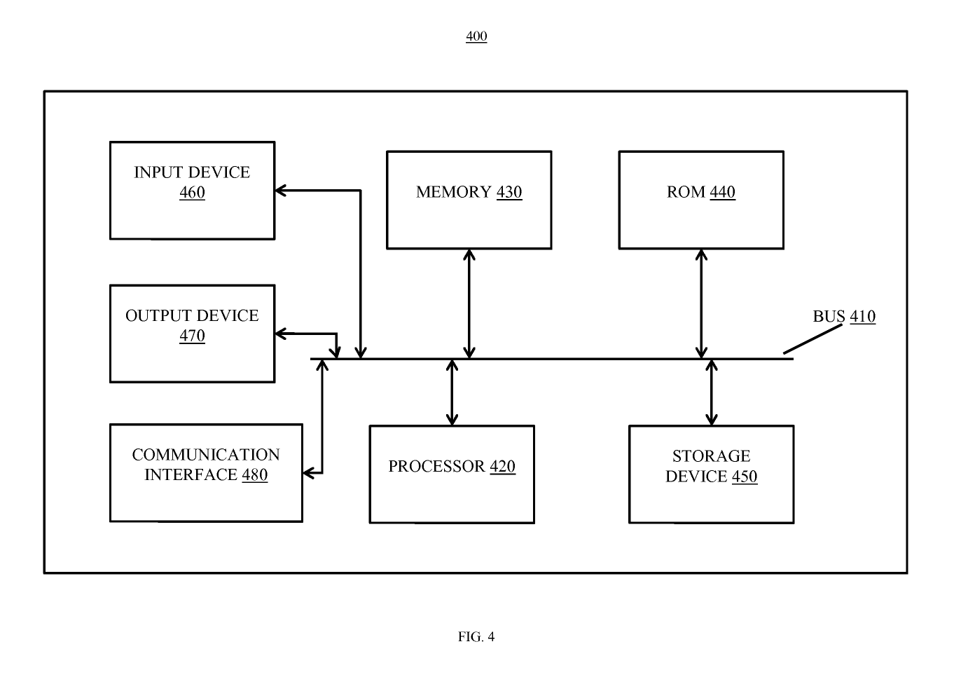

FIG. 4 depicts an exemplary architecture for implementing a computing device 400 in accordance with one or more embodiments, which may be used to implement any of the computing devices discussed herein, or any other computer system or computing device component thereof. It will be appreciated that other devices that can be used with the computing device 400, such as a client or a server, may be similarly configured. As illustrated in FIG. 4, computing device 400 may include a bus 410, a processor 420, a memory 430, a read only memory (ROM) 440, a storage device 450, an input device 460, an output device 470, and a communication interface 480.

Bus 410 may include one or more interconnects that permit communication among the components of computing device 400. Processor 420 may include any type of processor, microprocessor, or processing logic that may interpret and execute instructions (e.g., a field programmable gate array (FPGA)). Processor 420 may include a single device (e.g., a single core) and/or a group of devices (e.g., multi-core). Memory 430 may include a random access memory (RAM) or another type of dynamic storage device that may store information and instructions for execution by processor 420. Memory 430 may also be used to store temporary variables or other intermediate information during execution of instructions by processor 420.

ROM 440 may include a ROM device and/or another type of static storage device that may store static information and instructions for processor 420. Storage device 450 may include a magnetic disk and/or optical disk and its corresponding drive for storing information and/or instructions. Storage device 450 may include a single storage device or multiple storage devices, such as multiple storage devices operating in parallel. Moreover, storage device 450 may reside locally on the computing device 400 and/or may be remote with respect to a server and connected thereto via network and/or another type of connection, such as a dedicated link or channel.

Input device 460 may include any mechanism or combination of mechanisms that permit an operator to input information to computing device 400, such as a keyboard, a mouse, a touch sensitive display device, a microphone, a pen-based pointing device, and/or a biometric input device, such as a voice recognition device and/or a finger print scanning device. Output device 470 may include any mechanism or combination of mechanisms that outputs information to the operator, including a display, a printer, a speaker, etc.

Communication interface 480 may include any transceiver-like mechanism that enables computing device 400 to communicate with other devices and/or systems, such as a client, a server, a license manager, a vendor, etc. For example, communication interface 480 may include one or more interfaces, such as a first interface coupled to a network and/or a second interface coupled to a license manager. Alternatively, communication interface 480 may include other mechanisms (e.g., a wireless interface) for communicating via a network, such as a wireless network. In one implementation, communication interface 480 may include logic to send code to a destination device, such as a target device that can include general purpose hardware (e.g., a personal computer form factor), dedicated hardware (e.g., a digital signal processing (DSP) device adapted to execute a compiled version of a model or a part of a model), etc.

Computing device 400 may perform certain functions in response to processor 420 executing software instructions contained in a computer-readable medium, such as memory 430. In alternative embodiments, hardwired circuitry may be used in place of or in combination with software instructions to implement features consistent with principles of the disclosure. Thus, implementations consistent with principles of the disclosure are not limited to any specific combination of hardware circuitry and software.

Exemplary embodiments may be embodied in many different ways as a software component. For example, it may be a stand-alone software package, a combination of software packages, or it may be a software package incorporated as a “tool” in a larger software product. It may be downloadable from a network, for example, a website, as a stand-alone product or as an add-in package for installation in an existing software application. It may also be available as a client-server software application, or as a web-enabled software application. It may also be embodied as a software package installed on a hardware device.

Numerous specific details have been set forth to provide a thorough understanding of the embodiments. It will be understood, however, that the embodiments may be practiced without these specific details. In other instances, well-known operations, components and circuits have not been described in detail so as not to obscure the embodiments. It can be appreciated that the specific structural and functional details are representative and do not necessarily limit the scope of the embodiments.

It is worthy to note that any reference to “one embodiment” or “an embodiment” means that a particular feature, structure, or characteristic described in connection with the embodiment is included in at least one embodiment. The appearances of the phrase “in one embodiment” in the specification are not necessarily all referring to the same embodiment.

Although some embodiments may be illustrated and described as comprising exemplary functional components or modules performing various operations, it can be appreciated that such components or modules may be implemented by one or more hardware components, software components, and/or combination thereof. The functional components and/or modules may be implemented, for example, by logic (e.g., instructions, data, and/or code) to be executed by a logic device (e.g., processor). Such logic may be stored internally or externally to a logic device on one or more types of computer-readable storage media.

Some embodiments may comprise an article of manufacture. An article of manufacture may comprise a storage medium to store logic. Examples of a storage medium may include one or more types of computer-readable storage media capable of storing electronic data, including volatile memory or non-volatile memory, removable or non-removable memory, erasable or non-erasable memory, writeable or re-writeable memory, and so forth. Examples of storage media include hard drives, disk drives, solid state drives, and any other tangible storage media.

It also is to be appreciated that the described embodiments illustrate exemplary implementations, and that the functional components and/or modules may be implemented in various other ways which are consistent with the described embodiments. Furthermore, the operations performed by such components or modules may be combined and/or separated for a given implementation and may be performed by a greater number or fewer number of components or modules.

Some of the figures may include a flow diagram. Although such figures may include a particular logic flow, it can be appreciated that the logic flow merely provides an exemplary implementation of the general functionality. Further, the logic flow does not necessarily have to be executed in the order presented unless otherwise indicated. In addition, the logic flow may be implemented by a hardware element, a software element executed by a processor, or any combination thereof

While various exemplary embodiments have been described above, it should be understood that they have been presented by way of example only, and not limitation. Thus, the breadth and scope of the present disclosure should not be limited by any of the above-described exemplary embodiments.

1. A method of processing and accessing prison inmate data, comprising:
extracting from a plurality of sources, using a computer, attributes information about individuals that have a criminal case;
storing and organizing the extracted attributes information in a database;
matching, using a computer, the extracted attributes information with attributes data on a plurality of government websites;
determining whether an individual is currently in prison based on the matching;
providing a real-time location of the individual based on the determining; and
tracking the real-time location of the individual currently in prison for a duration of a prison term of the individual.

2. The method of claim 1, wherein the plurality of sources include public court records.

3. The method of claim 1, wherein the attributes information includes names of the individuals.

4. The method of claim 1, wherein the attributes information includes inmate numbers of the individual.

5. The method of claim 1, wherein the matching includes calculating whether the extracted attributes information is substantially identical to the attributes data on the plurality of websites.

6. The method of claim 1, wherein the plurality of government websites includes Department of Corrections websites.

7. A computer system for processing and accessing prison inmate data, the computer system comprising:
an extraction unit that is configured to extract, using at least one processor, from a plurality of sources attributes information about individuals that have a criminal case;
a data storage unit including a memory that is configured to store instructions;
a data processor that is configured to execute the instructions to:
store and organize the extracted attributes information in a database;
matching the extracted attributes information with attributes data on a plurality of Department of Corrections websites;
determine whether an individual is currently in prison based on the matching;
provide a real-time location of the individual based on the determining; and
track the location of the individual currently in prison for a duration of a prison term of the individual.

8. A non-transitory computer readable storage medium for processing and accessing prison inmate data, the computer readable storage medium including instructions that when executed by at least on processor cause a computer to perform:
extracting from a plurality of sources attributes information about individuals that have a criminal case;
storing and organizing the extracted attributes information in a database;
matching the extracted attributes information with attributes data on a plurality of Department of Corrections websites;
determining whether an individual is currently in prison based on the matching;
providing a real-time location of the individual based on the determining; and
tracking the location of the individual currently in prison for a duration of a prison term of the individual.
